(19) United States
(12) Patent Application Publication
(10) Pub. No.: US 2005/0125263 A1
(43) Pub. Date: Jun. 9, 2005

(54) System and method for re-accommodating passengers

(75) Inventors: Arnold H. Bramnick, Boca Raton, FL (US); J. Kendall Burch, Cooper City, FL (US); Lee E. Farnum, Fairfield, CT (US)

Correspondence Address: AKERMAN SENTERFITT, P. O. BOX 3188, WEST PALM BEACH, FL, 33402-3188, US

(73) Assignee: International Business Machines Corporation, Armonk, NY (US)

(21) Appl. No.: 10/730,845

(22) Filed: Dec. 9, 2003

(51) Int. Cl. G06F 17/60

(52) U.S. Cl. 705/5

(57) ABSTRACT

A method for re-booking passengers who are unable to travel on scheduled flights can include the step of obtaining passenger data for the passengers. The passenger data is compared with at least one rule. Re-booking flights are offered to the passengers based upon the comparing step. A system for re-booking passengers who are unable to travel on scheduled flights is also disclosed.

### BACKGROUND

1. Field of the Invention

This invention relates generally to the commercial airline industry and, more particularly to systems and methods for re-accommodating passengers who are unable to travel on scheduled flights.

2. Background of the Invention

Passengers sometimes are unable to travel on scheduled flights for a variety of reasons. Frequently the passenger is scheduled to make a connection and the passenger's inbound flight is delayed. Other times the connecting flight is cancelled because of mechanical problems, crew availability, weather conditions, or other factors. In other instances, the passenger's originating flight is cancelled. When passengers are unable to travel on scheduled flights, the passengers must be rescheduled on other flights.

Currently, such rescheduling decisions are based only on the availability of alternative flights. In the event that the only suitable alternative flights available are those of another airline, the original airline pays a pre-agreed price for the seat. In the event that the passenger is traveling on a low cost fare, the rerouting fee may be more than the value of the remaining ticket coupon. The airline then loses revenue on the connection.

Also, passengers who have proven loyal to the airline through frequent flyer status or the purchase of more expensive fares are treated the same as other passengers who must be rerouted. This can decrease passenger loyalty in the future.

### SUMMARY OF THE INVENTION

A method for re-booking one or more passengers who are unable to travel on scheduled flights can include obtaining passenger data for the passenger and comparing the passenger data with one or more rules. Re-booking flight candidates can be offered to the passenger based upon the comparing step.

The passenger data for the passenger can include any suitable passenger-related data. In one aspect, the passenger data can include the remaining unflown ticket value, the passenger re-booking cost, and the passenger lifetime value. Passenger lifetime value can include the frequent flyer status of the passenger, as well as the ticket purchase history of the passenger.

At least a portion of the passenger data can be provided real-time. In one aspect, all of the passenger data is provided real-time. This permits the airline to make up-to-date decisions regarding the booking of passengers based upon current financial data. The re-booking flights can be determined from flight inventory data and reservation data. The passenger data can be obtained from any suitable source. These sources can include accounting data, customer relationship management data, and loyalty data.

The comparing step can utilize a set of rules for comparing the passenger data. A value score can be assigned for each passenger using the passenger data. The re-booking flight candidates can be offered to the passenger based upon the passenger value score and the availability of seats.

A system for re-booking passengers who are unable to travel on scheduled flights can include means for obtaining re-booking flight candidates for the passengers. A means for obtaining passenger data for the passengers is also provided. Means are provided for selecting passengers for re-booking flights based upon the passenger data.

### BRIEF DESCRIPTION OF THE DRAWINGS

There are shown in the drawings embodiments which are presently preferred, it being understood, however, that the invention is not limited to the precise arrangements and instrumentalities shown.

FIG. 1 is a schematic diagram of a system according to one embodiment of the invention.

FIG. 2 is a flow diagram illustrating a method for re-accommodating passengers according to another embodiment of the invention.

### DETAILED DESCRIPTION OF THE INVENTION

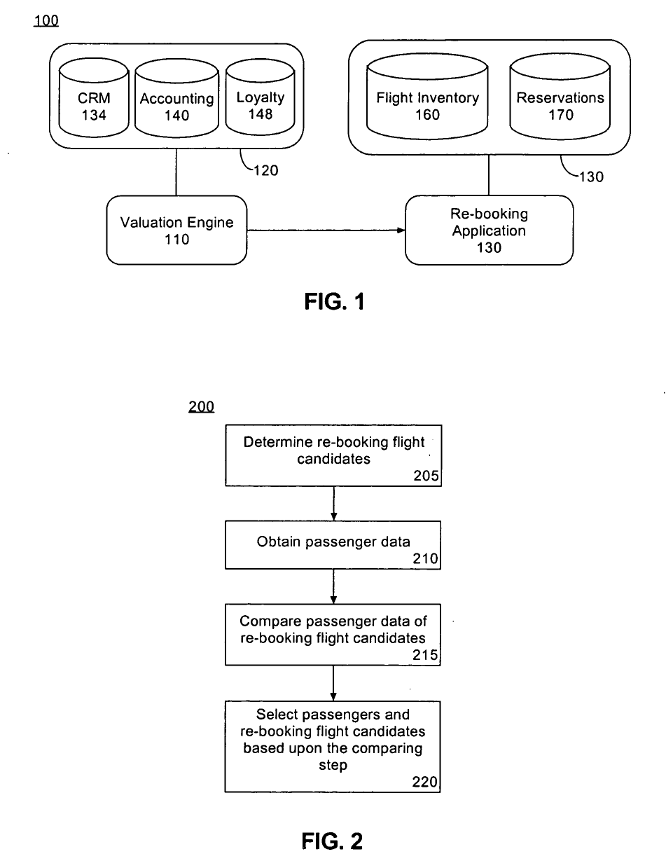

A system for re-booking passengers who are unable to travel on scheduled flights is shown in FIG. 1. The system 100 includes a valuation engine 110 for obtaining and processing passenger data 120. The valuation engine 110 can access suitable databases, including passenger data 120 to determine passenger valuations which can be passed to the re-booking engine 135. The flight operations data 130 can include existing databases within a re-booking application currently used by commercial airlines, or other suitable databases.

The valuation engine 110 and the re-booking engine 135, each can be implemented as applications executing within a suitable information processing system, such as a computer system or a server. While each application can be disposed within a different information processing system, it should be appreciated that both the valuation engine 110 and the re-booking engine 135 can be located within a same information processing system.

In one embodiment, the valuation engine 110 can be implemented as a standalone program. In another embodiment, however, the valuation engine 110 can be implemented as a plug-in or add-on for an existing re-booking system. Such can be the case, for example, where the re-booking engine 135 is a legacy system or an existing system. In any case, the valuation engine 110, if implemented as a standalone program, also can provide valuation information to an existing or legacy re-booking system.

The passenger data 120 can be any suitable data, including passenger financial data. The data can be obtained from existing airline databases, such as a customer relationship management (CRM) database 134, an accounting database 140, and a loyalty or frequent flyer database 148. Alternatively, or in addition, other databases can be used with the present invention.

The passenger data 120 can include any suitable passenger data. The passenger data 120 can include the frequent flyer status of the passenger, for example as specified by the CRM database 134, as the airline may wish to accommodate a frequent flyer. The passenger data 120 can also include the remaining unflown ticket value for each passenger, for example as specified by the accounting database 140. A passenger having a high remaining unflown ticket value may be preferentially offered re-booking flights, particularly if the failure to do so would result in a greater loss of revenue for the airline or if the passenger must be re-accommodated on another airline.

The re-booking cost for each passenger can be considered. The re-booking cost can include payments to other airlines if a passenger must travel on another airline, or the value of meals and hotel charges if re-booking of the passenger will involve an extended stay. Such information also can be specified within the accounting database 140. The lifetime value of the passenger, for example as specified in the CRM database 134, can also be considered. The airline may wish to accommodate a passenger if the passenger has a history of purchasing profitable tickets for the airline, such as business class tickets.

The flight operations data 130 can be any suitable flight operations data. The flight operations data 130 can include flight inventory data 160 and reservations data 170 on the airline and competitor airlines. For example, the flight operations data 130 can specify re-accommodation data which includes the availability of flights of the same airline, or whether the passenger must be re-accommodated on a competitor airline.

Although the flight operations data 130 and passenger data 120 are shown as being located in separate data stores, the data can be combined into a single data store, or provided in a plurality of data stores. Further, the flight operations data 130 can be included within the re-booking engine 135 while the passenger data 120 can be stored within the valuation engine 110. Still, one or more of the data stores can be remotely located from the valuation engine 110 and/or the re-booking engine 135.

The re-booking engine 135 can be programmed with rules for selecting among passengers according to a valuation provided from the valuation engine 110. In one aspect, the rules can require the selection of passengers according to the descending revenue impact on the airline. In another aspect, the rules can require selection based on the lifetime value of the passenger, which can be a valuation based upon factors such as frequent flyer status and/or the ticket purchase history of the passenger. In another aspect, the rules can weigh various passenger data according to the preferences of the airline and select those passengers with the most favorable scores. Each of the aforementioned attributes, and combinations thereof, can be considered. Further, it should be appreciated that the rules can specify how raw data can be processed to determine one or more of the aforementioned valuation metrics if such information is not directly available from one of the data stores.

As an example, Flight 123 is late on arrival by 45 minutes, causing 20 passengers to miss connections. The airline has enough available seats on flights to re-accommodate only 12 of the passengers. Some of the passengers are destined for Europe on the same airline, and thus may have a high remaining unflown ticket value such that it would be disadvantageous for the airline to rebook those passengers on another airline. Other passengers are flying on discounted tickets. Re-booking these passengers on other airlines results in the airline paying a pre-agreed price, known as an involuntary reroute, which can be in excess of the cost to the original airline to re-accommodate the passenger on another flight on which that airline may have seats. Finally, some passengers are frequent flyers or have a history of purchasing more profitable tickets such as business class tickets. The airline might wish to be more accommodating to these passengers.

The preferences can be programmed as a set of rules that are applied by the re-booking engine 135. Flight re-booking candidates for the passengers are obtained from the flight operations data 130. Passenger data 120 is obtained from databases such as the CRM database 134, the accounting database 140, and the loyalty database 148. The valuation engine 110 retrieves this data and provides the gathered data to the re-booking engine 135 which relies upon programmatic rules to select, from the passengers who must be re-accommodated, which flights the passengers will be offered.

The selection of passengers is provided to the airline personnel through any suitable system or display device. A computer terminal can be provided with a suitable graphical user interface for presenting to an airline employee the results obtained from the valuation engine 110 and/or the re-booking engine 135. These results can be a selection of passengers and assigned flights for these passengers. Alternatively, the airline employee can be provided with the output of the valuation engine 110 in a manner which permits the airline employee to make the selection based upon this output.

A method 200 according to the invention is shown in FIG. 2. The method can begin by determining re-booking flight candidates in step 205. Passenger data is obtained for passengers to be re-booked in step 210. The passenger data is compared with programmatic rules specified by the airline in step 215. Passengers are offered re-booking flights in step 220 based upon the comparison step 215. Notably, the comparison step can compare passenger data with valuations for the re-booking flight candidates and match passengers with the re-booking flight candidates according to the programmatic rules. Alternatively, an agent can be presented with a listing of passengers, a listing of re-booking flight candidates, and/or possible matches between the two listings.

In one embodiment, the valuation engine disclosed herein can determine a general valuation for a passenger that can be provided to the re-booking application. The re-booking application can utilize the valuation to determine which flights are to be presented or offered to passengers based upon rules and values of the re-booking flight candidates (or the cost or the re-booking flight candidates). In another embodiment, the valuation engine can retrieve information for passengers and provide that information to the re-booking engine. That is, the re-booking engine can identify passengers for which such information is needed and request that information from the valuation engine.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention can also be embedded in a computer program product, which comprises all the features enabling the implementation of the methods described herein, and which when loaded in a computer system is able to carry out these methods. Computer program in the present context means any expression, in any language, code or notation, on the set of instructions intended to cause a system having an information processing capability to perform a particular function either directly or after either or both of the following: (a) conversion to another language, code or notation; or (b) reproduction in a different material form.

This invention can be embodied in other forms without departing from the spirit or essential attributes and, accordingly, reference should be had to the following claims rather than to the foregoing specification as indicating the scope of the invention.

1. A method for re-booking passengers from cancelled flights, comprising the steps of:
obtaining passenger data for said passenger;
comparing said passenger data for said passenger with at least one rule; and
offering re-booking flights to said passenger based upon said comparing step.

2. The method of claim 1, wherein said passenger data for said passenger comprises the remaining unflown ticket value, the passenger re-booking cost, and the passenger lifetime value.

3. The method of claim 2, wherein said passenger lifetime value comprises at least one of the frequent flyer status of the passenger and the ticket purchase history of the passenger.

4. The method of claim 1, wherein said passenger data is provided real time.

5. The method of claim 1, wherein said re-booking flights are determined from flight inventory data and reservation data.

6. The method of claim 1, wherein said passenger data is obtained from at least one selected from the group consisting of accounting data, customer relationship management data, and loyalty data.

7. The method of claim 6, wherein a value score for said passenger is obtained using said passenger data, and said re-booking flights are offered to said passenger based upon said passenger value score.

8. A machine readable storage having stored thereon a computer program having a plurality of code sections executable by a machine for causing the machine to perform the steps of:
obtaining passenger data for said passenger;
comparing said passenger data for said passenger with at least one rule; and
offering re-booking flights to said passenger based upon said comparing step.

9. The method of claim 8, wherein said passenger data for said passenger comprises the remaining unflown ticket value, the passenger re-booking cost, and the passenger lifetime value.

10. The method of claim 9, wherein said passenger lifetime value comprises at least one of the frequent flyer status of the passenger and the ticket purchase history of the passenger.

11. The method of claim 8, wherein said passenger data is provided real time.

12. The method of claim 8, wherein said re-booking flight candidates are determined from flight inventory data and reservation data.

13. The method of claim 8, wherein said passenger data is obtained from at least one selected from the group consisting of accounting data, customer relationship management data, and loyalty data.

14. The method of claim 13, wherein a value score for said passenger is obtained using said passenger data, and said re-booking flights are offered to said passenger based upon said passenger value score.

15. A system for re-booking passengers who are unable to travel on scheduled flights, comprising:
means for obtaining re-booking flight candidates for said passengers;
means for obtaining passenger data for said passengers with at least one rule; and
means for selecting passengers for re-booking flights based upon said passenger data.
